(19) United States
(12) Patent Application Publication
(10) Pub. No.: US 2021/0021028 A1
(43) Pub. Date: Jan. 21, 2021

(54) WIRELESS COMMUNICATION SYSTEMS FOR AIRCRAFT

(71) Applicant: ICOMERA AB, Göteborg (SE)

(72) Inventors: MATS KARLSSON, Vålberg (SE); PETER EKLUND, Göteborg (SE); JOEL BJURSTRÖM, Göteborg (SE)

(21) Appl. No.: 16/647,343

(22) PCT Filed: Sep. 17, 2018
(86) PCT No.: PCT/EP2018/074988

§ 371 Date: Mar. 13, 2020

(30) Foreign Application Priority Data
Sep. 18, 2017 (SE) 1751148-6

(51) Int. Cl. H01Q 3/26; H04B 7/185; H01Q 1/28; H04B 7/204

(52) U.S. Cl. CPC H01Q 3/2605; H04B 7/2041; H01Q 1/286; H04B 7/18506

(57) ABSTRACT

Wireless communication systems for an aircraft are disclosed. In an embodiment, the wireless communication system includes a router, an antenna, a control unit, and an antenna steering unit. The router is connected to the antenna. The router is configured to transmit and receive wireless data communication to and from a stationary communication server outside the aircraft through at least one ground base station via the antenna. The antenna is a directional antenna. The control unit is configured to determine an attitude change of the aircraft by determining a change in at least one of a roll angle, a pitch angle, and a yaw angle of the aircraft. The antenna steering unit is connected to the control unit. The antenna steering unit is configured to steer an antenna beam of the directional antenna based on the attitude change of the aircraft.

### CROSS REFERENCE TO RELATED APPLICATIONS

This application is the United States national stage entry under 35 U.S.C. 371 of PCT/EP2018/074988 filed on Sep. 17, 2018, which claims priority to Swedish application number 1751148-6 filed on Sep. 18, 2017, the disclosure of which are incorporated by reference herein in their entireties.

### FIELD OF THE DISCLOSURE

The disclosure relates generally to the field of wireless communication technologies. More specifically, the disclosure relates to wireless communication systems and methods for aircraft such as helicopters and airplanes.

### BACKGROUND

It is not an understatement that the last few decades have introduced vast improvements and advancements in the field of communication technology. In fact, the advent of the internet and cellular phones, and more recently smart phones and tablets, has greatly changed the way we communicate and quite possibly accelerated technological fields surrounding these devices. As an inevitable consequence, there is an ever-increasing demand for bandwidth to satisfy the market need for online connectivity which results in an increased focus on constantly developing and improving the underlying technologies and systems to accommodate this demand.

Further, there is a rapidly increasing demand from consumers to communicate through mobile phones and other handheld terminals at all times, even while traveling on trains, busses, ships, and aircraft. This is partially embodied in the increasing availability of in-flight entertainment systems and wireless communication (Wi-Fi, GSM, 3G, LTE, 5G) capabilities on aircraft.

Wireless communication capability on aircraft is not a new concept. Even the earliest commercial aircraft had rather primitive voice communication capability with ground personnel over shortwave radio, which improved flight safety and enabled accelerated commercialization of air transportation. Since then, airborne communication systems have been further improved with advent of radar, computers, and data links, which all serve to improve in-flight safety as well as the overall traveling experience for passengers.

In efforts to provide connectivity to high bandwidth communication networks (e.g., Internet for aircraft), it is known that existing terrestrial cellular networks have potential for cost effective operation. However, the terrestrial cellular networks are designed for use by terrestrial equipment (e.g. handheld cell phones), but not for aircraft; therefore, successful use of terrestrial networks from aircraft depends on the ability to handle and work around the assumptions built in to such networks. Most predominantly, the assumption that the client device is terrestrial. One of the more prominent consequences of the assumption that the client device is terrestrial is the geographical cell size employed in these networks. The assumptions are accordingly that the client devices will have very limited range, reinforced by the fact that the radio propagation path between client devices and base stations is limited by obstructions (buildings, mountains, trees, et cetera) and the Earth's horizon. These assumptions are simply no longer valid from an airborne vantage point where the distance to the Earth's horizon is much larger, which leads to performance degradation in terms of interference between neighboring cells. Therefore, regardless of recent developments of communication platforms for aircraft, it has proven to be difficult to provide robust broadband data communication for aircraft such as airplanes, helicopters, et cetera.

In view of the above, there is a need for an improved wireless aircraft communication system which provides better capacity and improved reliability while still being cost-effective.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a wireless communication system for an aircraft. The wireless communication system includes a router, an antenna, a control unit, and an antenna steering unit. The router is connected to the antenna. The router is configured to transmit and receive wireless data communication to and from a stationary communication server outside the aircraft through at least one ground base station via the antenna. The antenna is a directional antenna. The control unit is configured to determine an attitude change of the aircraft by determining a change in at least one of a roll angle, a pitch angle, and a yaw angle of the aircraft. The antenna steering unit is connected to the control unit. The antenna steering unit is configured to steer an antenna beam of the directional antenna based on the attitude change of the aircraft.

Optionally, the antenna steering unit steers the antenna beam of the directional antenna to compensate for the attitude change.

Optionally, the antenna steering unit steers the antenna beam of the directional antenna to maintain a direction towards a predetermined sector of a ground surface below the aircraft by compensating for the attitude change.

Optionally, the directional antenna is a phased array antenna. The antenna steering unit is configured to electronically steer the antenna beam.

Optionally, the antenna steering unit includes a mechanical steering element. The antenna steering unit is configured to mechanically steer the antenna beam.

Optionally, the control unit is configured to determine at least one of a pitch angle and a roll angle of the aircraft. The antenna steering unit is configured to steer the antenna beam to deviate it from a nominal bore-sight direction by a deviation angle based on the at least one of the pitch angle and the roll angle.

Optionally, the control unit is configured to determine a change in yaw angle of the aircraft. The antenna steering unit is configured to steer the antenna beam to deviate it from a nominal bore-sight direction by a deviation angle based on the change in a yaw angle of the aircraft.

Optionally, the router is connected to a plurality of directional antennas defining at least two groups of directional antennas. Each group includes at least one directional antenna. Each group is configured to radiate and receive radio waves towards and from a selected sector of a ground surface below the aircraft. The selected sector is at least mostly non-overlapping.

Optionally, the antenna steering unit is configured to steer one or more of antenna beams of each group based on the attitude change of the aircraft to compensate for the attitude change.

Optionally, the antenna steering unit is configured to steer one or more of antenna beams of each group when the aircraft makes a change in attitude to maintain a direction towards the selected sector of a ground surface below the aircraft by compensating for the attitude change.

Optionally, the control unit is configured to evaluate a data link quality between each group and the at least one ground base station in the selected sector. The antenna steering unit is configured to steer one or more of antenna beams to radiate and receive radio waves towards and from a new sector of the ground surface below the aircraft when the data link quality is below a predefined quality threshold value.

Optionally, the new sector is in a direction in front of the aircraft along a planned traveling route.

Optionally, the antenna steering unit is configured to select the new sector by steering one or more of antenna beams along a search pattern until the data link quality is above a predefined establishment threshold value.

Optionally, the antenna steering unit is configured to steer one or more of antenna beams such that a direction of the one or more antenna beams is maintained towards the selected sector while steering the one or more antenna beams to radiate and receive radio waves towards and from the new sector.

Optionally, the wireless communication system further includes at least one of a gyroscope and an accelerometer to determine the attitude change.

In other embodiments, the disclosure provides a method for wireless data communication between a wireless communication system in an aircraft and a stationary communication server outside the aircraft. The method includes the following steps. (1) Providing a router within the aircraft. The router is connected to a directional antenna and configured to transmit and receive wireless data communication to and from the stationary communication server outside the aircraft through at least one ground base station via the directional antenna. (2) Determining an attitude change of the aircraft by determining a change in at least one of a roll angle, a pitch angle, and a yaw angle of the aircraft. (3) Steering an antenna beam of the directional antenna based on the attitude change of the aircraft.

Optionally, the step (3) further includes a step of maintaining a direction towards a predetermined sector of a ground surface below the aircraft by compensating for the attitude change.

Optionally, the method further includes the following steps. Evaluating a data link quality between each group of at least two groups of directional antennas and the at least one ground base station in a selected sector of a ground surface below the aircraft. Steering the antenna beam such that at least one antenna in at least one of the evaluated group radiates and receives radio waves towards and from a new sector of the ground surface when the data link quality is below a predefined quality threshold value. Here, the router is connected to a plurality of directional antennas defining the two groups of directional antennas. Each of the two groups of directional antennas includes at least one directional antenna. Each of the two groups of directional antennas is configured to radiate and receive radio waves towards and from the selected sector. The selected sector is at least mostly non-overlapping.

### BRIEF DESCRIPTION OF THE DRAWINGS

Illustrative embodiments of the present disclosure are described in detail below with reference to the attached drawing figures.

FIG. 1 is a partially exploded perspective view of an aircraft having a wireless communication system according to an embodiment of the disclosure.

FIG. 2A is a top view of an aircraft having a wireless communication system in according to an embodiment of the disclosure.

FIG. 2B is a perspective view of the aircraft in FIG. 2A making a roll maneuver.

FIG. 2C is a perspective view of the aircraft in FIG. 2A making a pitch maneuver.

FIGS. 3A-3E are top view examples of an aircraft having a wireless communication system according to some embodiments of the disclosure.

FIG. 4 is a flowchart illustration a wireless data communication method according to an embodiment of the disclosure.

### DETAILED DESCRIPTION

The following describes some non-limiting embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

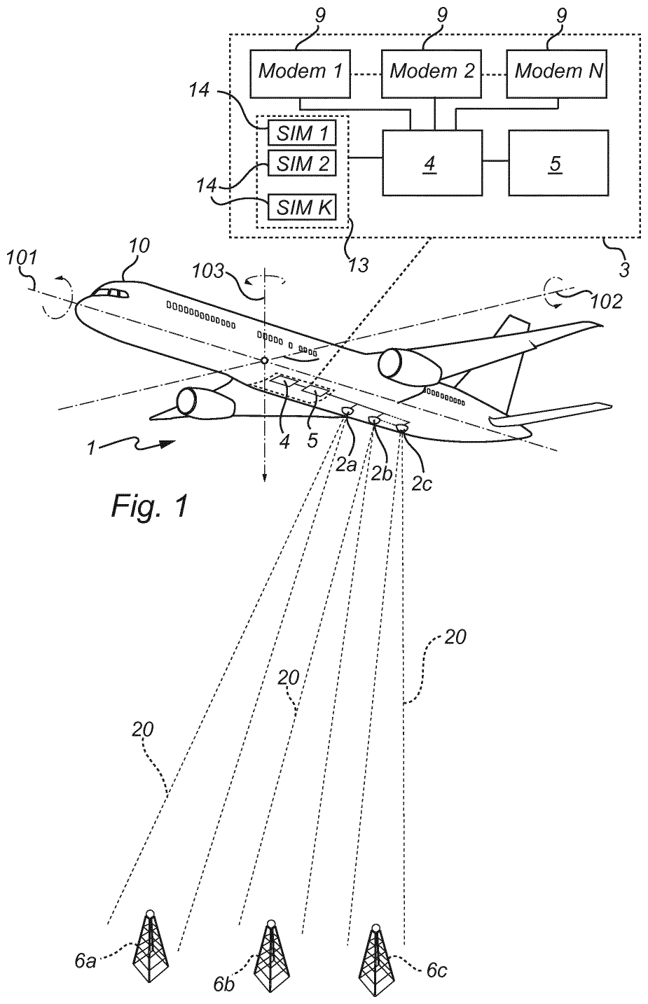

FIG. 1 is a perspective view of an aircraft 10 (e.g., an airplane) having a wireless communication system 1 according to an embodiment of the disclosure. The system 1 has a router 3 connected to a plurality of (external or internal) antennas 2a-2c. The router 3 is configured to transmit and receive wireless data communication to and from a stationary communication server outside the aircraft 10 through at least one ground base station 6a-6c via the antennas 2a-2c. The antennas 2a-2c are directional antennas which may for example be passive beam forming arrays having various polarizations. Moreover, each one of the antenna 2a-2c may be implemented as an antenna orthogonal pair by using a dual polarized antenna setup with a 90-degree angle between two linear polarizations or using circular left-handed and right-handed polarizations. However, in alternative embodiments, spatial diversity may be utilized to achieve orthogonal antenna diversity.

The antennas 2a-2c may be mounted to an external surface of the aircraft 10. For example, they may be mounted to the aircraft's 10 fuselage. However, the antennas 2a-2c may also be integrated in the external surface of the aircraft 10. Alternatively, a combination of these two configurations is also feasible.

The system 1 may further include a control unit 4 (e.g. a microprocessor) configured to determine an attitude change of the aircraft 10 by determining a change in at least one of a roll angle, a pitch angle, and a yaw angle of said aircraft. The control unit 4 may be implemented as a software controlled processor. However, it may alternatively be implemented wholly or partially in hardware. In addition, the system 1 may further include at least one of a gyroscope and an accelerometer so that the attitude change may be determined by one or more of gyroscopes and accelerometers. A change in a roll angle is to be understood as the aircraft 10 making a rotation about its longitudinal axis 101, also commonly referred to as a roll axis. Similarly, a change in a pitch angle is to be understood as the aircraft 10 making a rotation about its lateral/transverse axis 102, also commonly referred to as a pitch axis, and a change in a yaw angle is to be understood as the aircraft making a rotation about its vertical axis 103, also commonly referred to as a yaw axis.

The system 1 may further include an antenna steering unit 5 connected to the control unit 4. The antenna steering unit 5 may be configured to steer the antenna beams 20 of each directional antenna based on the determined attitude change of the aircraft 10. Even though the control unit 4 and antenna steering unit 5 are here illustrated as two separate entities, a skilled artisan would readily realize that these may be integrated into one single unit. The antenna steering unit may for example be in the form of an electronic antenna steering unit which steers the antenna one or more of beams 20 by switching the antenna elements or changing the relative phases of the RF signals driving the antenna elements. The antennas may be in the form of passive beam forming arrays including a plurality of antenna elements. However, additionally or alternatively, the antenna steering unit 4 may include a mechanical steering element (e.g. an actuator mounted to the antennas) to mechanically or physically steer the antennas 2a-2c.

The router 3 may further include a plurality of modems 9, where each one of antenna 2a-2c, or each antenna orthogonal pair, is assigned and connected to a separate modem 9. In case of the latter, each modem 9 is optionally provided with 2 antenna ports for connection to each orthogonal antenna pair. However, each modem may also be provided with four or more ports to operate in compliance with Multiple Input Multiple Output (MIMO) configurations. Moreover, the router 3 may include a subscriber identity module pool (SIM pool) 13, which may include a plurality of SIMs 14. The control unit 8 may be accordingly configured to periodically assign SIMs 14 within the SIM pool 13 to any one of the plurality of modems 9 provided within the router 3. In other words, the SIMs 14 form a common SIM pool 13 accessible for all the modems 9. The SIMs 14 may be SIM cards, and the SIM pool 13 may be implemented as a SIM card holder including a plurality of slots for receiving a plurality of SIM cards 14.

Optionally, the assignment of SIMs to modems at every specific time is determined based on a set of rules in the controller. The set of rules may be used to assign SIMs to the modems based on information such as the current altitude of the aircraft 10, which country the aircraft is currently travelling, the amount of data that has been conveyed by use of the different SIMs, the current price related to conveying data through the different SIMs, the type of data being conveyed, et cetera.

Optionally, the router 3 may be configured to receive and transmit data between an internal local area network (LAN) and a plurality of external wide ware networks (WANs). The LAN may be a wireless network using one or several internal antennas to communicate with clients within the aircraft 10. To this end, a distributed antenna, such as a leaky feeder extending through the vehicle, may be used; however, other types of antennas may also be used. The wireless network may be implemented as a wireless local area network (WLAN), and may operate in compliance with IEEE 802.11 (“Wi-Fi”) standards. One or more access points may be provided in the aircraft. However, it may also be possible to use a wired network within the vehicle.

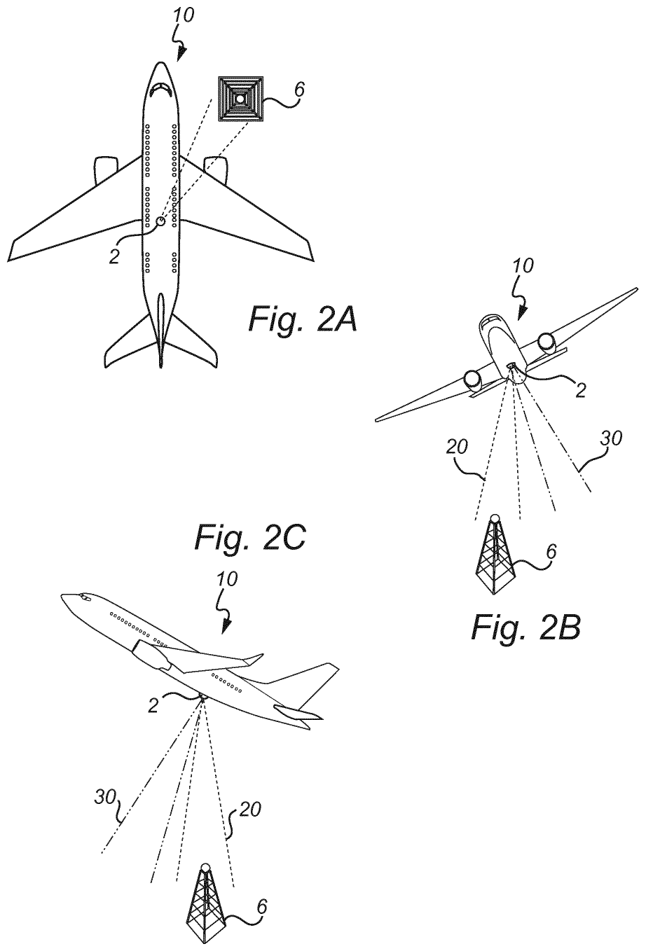

FIG. 2A is a top view of an aircraft 10 having a wireless communication system according to an embodiment of the disclosure. Here, the aircraft may be provided with one directional antenna 2 with an antenna beam or radiation pattern schematically indicated by the dash-dotted lines 30. More specifically, the dash-dotted lines 30 represent “bore-sight” direction of the antenna. For example, its nominal pointing direction. The antenna beam 30 in FIG. 2A may target a predetermined sector on the ground surface below the aircraft. The sector may include a ground base station 6, to which a router within the aircraft 10 connected to the antenna 2 may transmit and receive wireless data communication to and from an external stationary communication server.

FIG. 2B is a perspective view of an aircraft from FIG. 2A during a roll maneuver. In other words, the aircraft 10 has changed its roll angle as compared to the horizontal stable orientation illustrated in FIG. 2A. Accordingly, the control unit of the router may determine the attitude change of the aircraft by a gyroscope, whereby the antenna steering unit may steer the antenna beam 20 of the antenna 2 to compensate for the determined attitude change. The dash-dotted lines 30 illustrate that the antenna beam 20 has deviated from its bore-sight direction 30. The steering unit may steer the antenna beam 20 of the antenna 2 such that the antenna beam 20 maintains a direction towards the predetermined sector of a ground surface below the aircraft by compensating for the determined roll angle or attitude change.

Similarly, FIG. 2C is a perspective view of an aircraft from FIG. 2A during a pitch maneuver. In other words, the aircraft 10 has changed its pitch angle as compared to the horizontal stable orientation illustrated in FIG. 2A. The control unit of the router may determine the attitude change of the aircraft by a gyroscope, whereby the antenna steering unit may steer the antenna beam 20 of the antenna 2 to compensate for the determined attitude change. The dash-dotted lines 30 illustrate that the antenna beam 20 has deviated from its bore-sight direction 30. The steering unit may steer the antenna beam 20 of the antenna 2 such that the antenna beam 20 maintains a direction towards the predetermined sector of a ground surface below the aircraft by compensating for the determined pitch angle or attitude change.

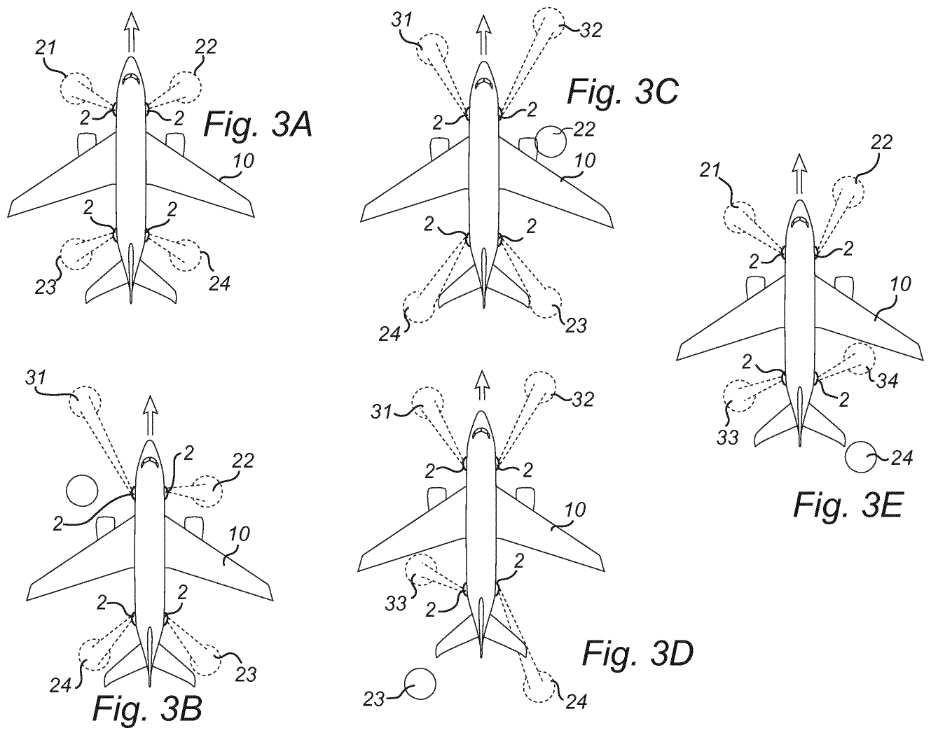

Further, FIG. 3A is a top view of an aircraft 10 having a wireless communication system according to an embodiment of the disclosure. The system may include a router connected to a plurality of directional antennas 2 which may define four groups of directional antennas. Here, the four groups may spatially separate along the aircraft's 10 fuselage to primarily target four separate quadrants of the ground surface below the aircraft. Each group may have a directional antenna 2 and each group may be configured to radiate and receive radio waves towards and from a selected sector 21-24 of a ground surface below the aircraft 10. The sectors 21-24 may be optionally non-overlapping, but may be at least mostly non-overlapping as some overlap may be acceptable.

The series of FIGS. 3A-3E illustrate how the antenna steering unit may be utilized to steer the antenna beams to select new sectors to be targeted during the flight to minimize the otherwise “continuous sweeping” of the ground surface by the antenna beam which may require a large number of handovers per unit of time and therefore lead to a reduced network performance. Instead, a control unit of the router may be configured to evaluate a data link quality between each group and at least one ground base station in the selected sector 21-24, and based on this data, the antenna steering unit may be configured to steer the one or more antenna beams towards a new sector 31-34 when the data link quality falls below one or more threshold values, which may be due to a too long of a distance between the antenna and the base station. In addition, the steering of the one or more antenna beams of each individual group may be performed sequentially one at a time. For example, one antenna beam may be steered towards a new sector while the remaining ones maintain their selected “old” sector, or other configurations may be feasible in which 2 at a time, 3 at a time, and so on depending on the number of groups and other specifications.

FIG. 3B illustrates how the steering unit may control the antenna beam of the first group (top left in reference to the illustrated aircraft 10) to select a new sector 31 which may be located in front of the aircraft along a planned traveling route. The selection may be based on predefined data provided by a GNSS (e.g. a GPS) and/or by steering the antenna beam along a predefined search pattern (e.g. a spiral path). The antenna beams of the remaining antenna groups may be instead steered to maintain a direction towards their previously selected sectors 22-24. Similarly, FIGS. 3C-3E show a series of embodiments illustrating how the antenna steering unit sequentially controls the antenna beam of each group to search for a new sector while the antenna beams of the remaining groups are steered to maintain their direction towards a current sector.

Optionally, other beam steering configurations may also be implemented within the scope of the disclosure. For example, with reference to the system configuration illustrated in FIGS. 3A-3E, the wireless communication system may include four groups of antennas. The antenna steering unit may be configured to steer the antenna beams of the four groups in pairs. Specifically, the antenna steering unit may be configured to steer diagonal pairs separately; that is, the top left and bottom right antenna groups may be steered towards a new sector while the remaining two may be steered to maintain the antenna beam(s) aimed at their current sectors. Subsequently, the top right and bottom left antenna groups may be steered towards a new sector while the remaining two may be steered to maintain the antenna beam(s) aimed at their current sectors, which may be similar to a horse trotting configuration. Left and right may be in reference to the illustrated aircraft 10 in FIGS. 3A-3E. However, in another manner, the antenna steering unit may be configured to steer front two groups towards a new sector together while the back two may be steered so to maintain the antenna beam(s) aimed at their current sectors. Front and back may be in reference to the nose and tail of the aircraft 10.

Optionally, the four groups may be paired with respect to which side of the aircraft they are arranged; that is, the top left and bottom left antenna groups may be steered towards a new sector while the remaining two may be steered to maintain the antenna beam(s) aimed at their current sectors. Subsequently, the top right and bottom right antenna groups may be steered towards a new sector while the remaining two may be steered to maintain the antenna beam(s) aimed at their current sectors. Left and right may be in reference to the illustrated aircraft 10 in FIGS. 3A-3E.

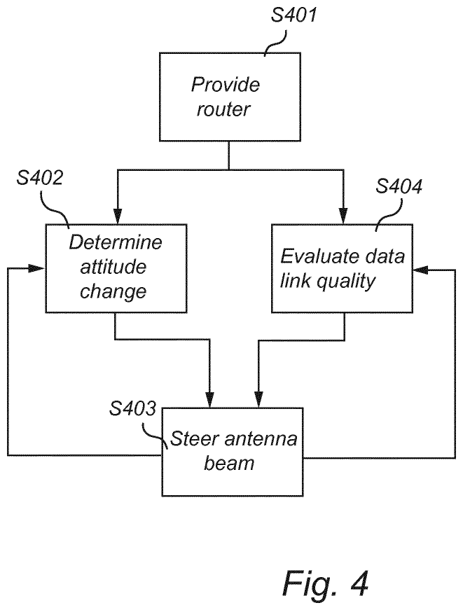

FIG. 4 is a flowchart illustrating a method for wireless data communication between a wireless communication system in an aircraft and a stationary communication server outside the aircraft according to an embodiment of the disclosure. The method may include a step S401 of providing a router within the aircraft. The router may be connected to at least one directional antenna and configured to transmit and receive wireless data communication to and from the stationary communication server outside the aircraft through at least one ground base station via the one or more directional antennas.

Further, an attitude change of the aircraft may be determined in step S402 by determining a change in at least one of a roll angle, a pitch angle, and/or a yaw angle of the aircraft. Afterwards, an antenna beam (or radiation pattern) of the at least one directional antenna may be steered in step S403 based on the determined attitude change of the aircraft in step S402. Specifically, the steering of the antenna beam in step S403 may include maintaining a direction (of the antenna beam) towards a predefined sector of the ground surface below the aircraft by compensating for the determined attitude change in step S402. Therefore, the antenna may be kept in communication with any ground base stations in that sector in spite of any attitude changes.

Optionally, the steering of the antenna beam(s) in step S403 may be based on an evaluation of a data link quality between each antenna and the one or more base stations in step S404 which are present in the sector of the ground surface to which each antenna is arranged to target. Accordingly, the steering of the antenna beams in step S403 may be done such that the “evaluated” antennas radiate and/or receive radio waves towards/from a new sector of the ground surface when the data link quality is below a predefined quality threshold value.

Various embodiments of the disclosure may have one or more of the following effects.

In some embodiments, the disclosure may provide wireless communication systems and methods for an aircraft, such as a helicopter or an airplane, which may help to alleviate all or at least some of the drawbacks of presently known systems. The disclosure may provide means for robust and stable wireless connectivity in aircraft. Disclosed wireless communication systems and methods may provide wireless data communication between a wireless communication system in an aircraft and a stationary communication server outside the aircraft.

In other embodiments, the disclosure may provide a wireless communication system for an aircraft. The wireless communication system may include a router, an antenna, a control unit, an antenna steering unit. The router may be connected to the antenna, and configured to transmit and receive wireless data communication to and from a stationary communication server outside the aircraft through at least one ground base station via the antenna. The antenna may be a directional antenna. The control unit may be configured to determine an attitude change of the aircraft by determining a change in at least one of a roll angle, a pitch angle, and/or a yaw angle of the aircraft. The antenna steering unit may be connected to the control unit and configured to steer an antenna beam of the directional antenna based on the determined attitude change of the aircraft.

In further embodiments, the disclosure may provide an aircraft communication system which may mitigate the negative impacts of rapid aircraft movements and which may improve network connection stability.

The disclosed systems and methods may be at least partially based on the premise that due to distance to the horizon being relatively large form an airborne vantage point, there is a large number of network cells simultaneously “visible” for the communication system. Therefore, a radio device in the aircraft, which tries to communicate with one network cell, may interfere with other network cells operating on the same frequency, and receive interference from the network cells with which it is not trying to communicate. One way to mitigate this may be using directional antennas; that is, antennas which have a relatively sharply focused beam to limit the geographical area “seen” by each antenna, and therefore by the radio.

For optimum performance, the antenna radiation pattern may be focused as sharply as possible; however, the sharper the radiation pattern (e.g., the beam), the smaller a change in the aircraft's attitude (pitch, roll or yaw) is necessary to lose the connection to a particular base station. A similar situation would be like trying to target an object on a ground surface with a laser mounted to an aircraft—minimal changes in the aircraft attitude will move the laser point a great distance, and at a very great speed, on the ground surface.

The disclosed systems and methods may enable an antenna beam as sharp as possible while reducing the negative effects of rapid attitude changes by the aircraft. It may be patentably desirable to use an antenna steering unit which may (electronically and/or mechanically) steer the direction of the antenna beam of some antennas in the system based on information of the aircraft's attitude changes. The attitude changes of the aircraft may be detected by means of a rate-gyro and/or an accelerometer, which may be individually or in combination utilized in a sensor-fusion algorithm such as a Kalman filter. The act of steering an antenna beam may also be known as a beam-steering operation, and is to be understood as changing the direction of the main lobe of a radiation pattern of an antenna. For example, by switching the antenna elements or changing the relative phases of the RF signals driving the antenna elements. Accordingly, the directional antenna may include a plurality of antenna elements in the form of a phase array or the like, as known in the art.

The “router” may be a networking router, which is a machine that forwards data packets between computer networks, optionally on at least two data links in each direction. In other words, the networking router may provide data communication between an internal local area network (arranged within the aircraft) and an external wide area network (WAN) outside the aircraft. The router may be a mobile access router (MAR) or a mobile access and applications router (MAAR). The router may further include means (e.g. a control unit or controller) for determining attitude changes of the aircraft. Optionally, the router may include means for detecting or determining an attitude change of the aircraft, either by having a control unit connected to the aircraft's own sensory systems, or by arranging one or more accelerometers and/or gyroscopes (e.g. rate gyros or a three-axis gyroscopes) within the router connected to the control unit. In the latter case, retrofitting to existing aircraft may be facilitated as the need for configuring the router to comply and cooperate with various systems of the aircraft may be reduced. Optionally, the whole wireless communication system may be a type of plug and play solution.

The antenna steering unit and the control unit in some embodiments may be in the form of an integrated unit or separate units depending on the intended application and product specifications. For example, the antenna steering unit may include a mechanical steering unit which may be configured to physically move the antenna or any antenna elements; however, in another example, the antenna steering unit may be an electronic steering unit which may be partially or wholly integrated in the control unit of the router. Optionally, the antenna steering unit may be a combination of the two, or in other words, may be based on combined electronic and mechanical steering.

In terms of general operation of the communication system, the router and the stationary (remote) communication server may be connected through a plurality of exterior mobile/cellular networks (provided by the ground base stations), which may be simultaneously useable. Optionally, the router may be arranged to communicate with the stationary communication server on at least two different data links (communication routes) having different characteristics (e.g. on different frequency bands), and then to automatically separate the data traffic between the data links based on an evaluation of link quality. The evaluation of link quality may for example be executed as disclosed in WO 2015/169917, by the same applicant, which is incorporated herein by reference in its entirety. The data streams may be then forwarded on one or several links to and from a dedicated external server, which may be referred to as an aggregation server or gateway. The different links thereby form a single virtual link between the router and the gateway.

Optionally, the antenna steering unit may be further configured to steer the antenna beam of the directional antenna based on the determined attitude change of the aircraft to compensate for the determined attitude change. In other words, the antenna steering unit may be configured to completely or at least partially counter-act the attitude changes of the aircraft to at least partially decouple the direction of the antenna beam from the aircraft's movements. The term “compensate” in the present context is to be understood as counter act or at least reduce (the unwanted antenna beam deviations caused by aircraft attitude changes) by exerting an opposite force or effect. Thus, the attitude change may not be entirely compensated for, but may instead be only partially compensated for such that the antenna beam maintains a general direction towards a predetermined sector of a ground surface below the aircraft.

However, in various embodiments of the disclosure, the antenna steering unit may be configured to steer the antenna beam of said antenna, when said aircraft makes a change in attitude, such that said antenna beam maintains a direction towards a predetermined sector of a ground surface below the aircraft by compensating for said determined attitude change. Accordingly, loss of connection between the router and one or more specific base stations located within a predetermined sector may be prevented to some extent. As a result, during a pitch or roll maneuver, the beam steering angle (e.g., the angle between the main direction of the antenna beam or radiation pattern and the antenna's bore-sight direction in the aircraft's vertical transverse and vertical longitudinal planes) may be adjusted to deviate by a corresponding amount as the aircraft's pitch and roll angles.

Optionally, the directional antenna may be a phased array antenna and the antenna steering unit may be configured to electronically steer said antenna beam. However, a skilled artisan would understand that the antenna steering unit may include a mechanical steering element, and the antenna steering unit may be configured to mechanically steer the antenna beam.

In some embodiments, the control unit may be configured to determine a pitch angle and/or a roll angle of the aircraft. The antenna steering may be is configured to steer the antenna beam such that it deviates from a nominal bore-sight direction by a deviation angle based on the determined pitch angle and/or roll angle. Since pitch and roll maneuvers may be temporary maneuvers (maneuvers that are performed only for relatively short durations of time before reverting back to a stable horizontal position), the compensation made by the antenna steering unit may be based directly on the pitch or roll angle. For example, the antenna steering unit may be configured to steer the antenna beam angle (e.g., the angle between the radiation pattern and the bore-sight direction in the aircraft vertical transverse and vertical longitudinal planes) to be at least approximately equal to the aircraft's pitch and roll angles at all times. Optionally, the control unit may be configured to determine a pitch angle and/or a roll angle in reference to a state when the aircraft is in a horizontal, stable flight.

In other embodiments, the control unit may be configured to determine a change in yaw angle of the aircraft. The antenna steering unit may be configured to steer the antenna beam such that it deviates from a nominal bore-sight direction by a deviation angle based on the determined change in a yaw angle of the aircraft. While pitch and roll changes may be at most times temporary, yaw changes may often be intentional and more permanent. For antenna beam adjustments related to yaw changes, a mathematical decay function may be used, to the effect that antenna beam angle is merely dampened with respect to the yaw changes of the aircraft, not directly to the actual yaw angle. This may be useful since a yaw change generally may be more of a permanent attitude adjustment, and the maximum beam steering angle may be limited (e.g. ±20°, ±30°, ±35° or ±40°). Therefore, the antenna steering unit may be configured such that a rapid yaw change of the aircraft results in an approximately equal rapid and opposite, initial, change in antenna beam angle. The antenna beam angle may be subsequently, slowly, returned to the bore-sight direction (nominal pointing direction).

In further embodiments, more advanced algorithms may be used to take into account for angular moment of the aircraft and the yaw-rate of change. Such algorithms may either allow a higher initial ground-referenced angular velocity of the antenna beam to avoid a “bump” in angular velocity when the maximum beam-steering is reached, or lock the beam to one ground-referenced angle for as long as possible and when the maximum beam-steering angle is reached, move the beam instantaneously to an angle that anticipates or pre-empts the continued yaw change of the aircraft. The aircraft may not be able to stop its yaw change instantaneously due to its angular momentum; as a result, the instantaneous beam-steering angle change might as well be large enough such that, when the change in yaw angle has stopped, the beam-steering angle may be within the angular range of the beam-steering.

In some embodiments, the router may be connected to a plurality of directional antennas defining at least two groups of directional antennas. Each group may include at least one directional antenna and each group may be configured to radiate and/or receive radio waves towards/from a selected sector of a ground surface below the aircraft. The selected sectors may be at least mostly non-overlapping, and it may be patentably desirable for the selected sectors to be totally non-overlapping. By configuring the system such that the different groups of antennas cover different, optionally non-overlapping sectors of the ground surface below, problems related to signal interference may be reduced. However, a small amount of overlap may still be acceptable, such as an area overlap of less than 25%, less than 20%, less than 15%, less than 10%, or less than 5%. Each group may include a plurality of directional antennas. For example, each group may be configured to be compatible with a plurality of different operators, therefore having one or more antennas for each operator.

In other embodiments, the antenna steering unit may be configured such that the antenna beam(s) of each group may be based on the determined attitude change of said aircraft to compensate for said determined attitude change. As a result, the system may have a plurality of different sectors that may be targeted by separate antenna groups without interruptions in the communication path due to attitude changes of the aircraft, which may render the communication system more robust and reliable. Optionally, the antenna steering unit may be configured to steer the antenna beam(s) of each group, when said aircraft makes a change in attitude, such that said antenna beam(s) in each group maintain(s) the direction towards the selected sector of a ground surface below the aircraft by compensating for said determined attitude change. As a result, the connection stability may be improved and the risk of the communication system losing contact with one or more ground base stations due to attitude changes of the aircraft may be reduced.

In further embodiments, the control unit may be configured to evaluate a data link quality between each group and the at least one ground base station in the selected sector. The antenna steering unit may be configured to steer the antenna beam(s) to radiate and/or receive radio waves towards/from a new sector of the ground surface when the data link quality is below a predefined quality threshold value. As a result, the system may be arranged to be self-regulating in that it may maintain a minimum link quality level for each group of antennas. Specifically, the aircraft will be traveling rather rapidly above ground wherefore a static antenna beam would result in relatively large number of handovers as the antenna beam “scans” the ground surface below a velocity corresponding the aircraft's “ground speed”. Thus, by utilizing the antenna steering unit to maintain the connection to a selected sector (having one or more ground base stations) until the link quality is too low, a lower number of handovers may be required compared to the static situation where the antenna beam continuously “scans” the ground surface. Optionally, by having a plurality of groups of antennas targeting different sectors on the ground, the system may be arranged such that there is always at least one group of antennas maintaining a connection to a specific sector while one or more other antenna groups may be scanning for a new sector.

Here, the new sector may be in a direction in front of the aircraft along a planned traveling route. According to an embodiment, the router may be connected to two different groups having one or more directional antennas. The antenna steering unit may then be configured to steer the antenna beam(s) of each group to target and maintain a direction towards two different, optionally non-overlapping sectors on the ground surface below the aircraft. However, as the aircraft travels, the sectors will be located further and further behind the aircraft, wherefore the link quality will decrease over time. Thus, when a search for a new sector is to be performed, it may be advantageous to ensure that it is located in front of the aircraft since the same sectors (and the associated ground base stations) may be utilized for a longer duration of time, requiring less handovers and thereby less interruptions in connectivity.

In some embodiments, the antenna steering unit may be configured to select the new sector by steering the antenna beam(s) along a search pattern until the data link quality is above a predefined establishment threshold value. The antenna steering unit may be configured to follow a specific search pattern (e.g. spiral) while searching for a new sector including the appropriate ground base stations. Optionally, the system may include a Global Navigation Satellite System, GNSS, provided within the router, such as GPS, GLONASS, Galileo system, BeiDou system, et cetera. The GNSS may be connected to the control unit and/or the antenna beam steering unit in which the antenna beam(s) may be directed towards predefined sectors of the ground surface below the aircraft based on GNSS data. Optionally, the control unit or the GNSS may be provided with a planned route including a plurality of different sectors along the route and the selection of the new sector may be based on a predetermined series of pre-selected sectors along the route.

In other embodiments, the steering unit may be configured to the antenna beam(s) of each group sequentially such that the direction of the antenna beam(s) of at least one group may be maintained towards the selected sector(s) while steering the antenna beam(s) of at least one different group to radiate and/or receive radio waves towards/from the new sector. When travelling in the air, the aircraft will pass through a large number of cells; therefore, a certain level of connectivity may be maintained by sequentially switching to new cells (sectors) along the travel route. For example, if the system would include four groups of antennas targeting four different sectors (cells), the system may be configured such that at any given time three or at least two groups are arranged to maintain the antenna beam(s) to receive/transmit from/to a selected cell while the remaining one or two groups are steered towards a new cell, which may be similar to a horse trotting configuration where two legs are on the ground and the other two are moving forward.

In further embodiments, the disclosure may provide a method for wireless data communication between a wireless communication system in an aircraft and a stationary communication server outside the aircraft. The method may include the following steps. (1) Providing a router within the aircraft, the router being connected to a directional antenna and configured to transmit and receive wireless data communication to and from the stationary communication server outside the aircraft through at least one ground base station via the directional antenna. (2) Determining an attitude change of the aircraft by determining a change in at least one of a roll angle, a pitch angle, and/or a yaw angle of the aircraft. (3) Steering an antenna beam of the directional antenna based on the determined attitude change of the aircraft.

Similar advantages or preferred features may be presented as in the previously discussed embodiments, and vice versa. For example, the step of steering the antenna beam may include maintaining a direction towards a predetermined sector of a ground surface below the aircraft by compensating for said determined attitude change.

Optionally, according to embodiments of the disclosure, the router may be connected to a plurality of directional antennas defining at least two groups of directional antennas. Each group may include at least one directional antenna and each group may be configured to radiate and/or receive radio waves towards/from a selected sector of a ground surface below the aircraft. The individual sectors may be at least mostly non-overlapping, and optionally non-overlapping, the method may further include the following steps: evaluating a data link quality between each group and the at least one ground base station in the selected sector; and steering said antenna beam(s) such that said at least one antenna in the evaluated group radiates and/or receives radio waves towards/from a new sector of the ground surface when said data link quality is below a predefined quality threshold value.

The invention has now been described with reference to specific embodiments. However, several variations of the communication system are feasible. For example, the control unit may be considered to include the antenna steering unit, the number of modems may vary, and so on. Moreover, more advanced mathematical algorithms for compensating for yaw changes may be employed in order to take into account the angular moment of the aircraft and the yaw rate-of-change, in order to account for a situation where the yaw changes so rapidly that the beam steering reaches its maximum possible angle, as already exemplified. Such and other obvious modifications must be considered to be within the scope of the disclosure, as it is defined by the appended claims. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting to the claim. The word “including” does not exclude the presence of other elements or steps than those listed in the claim. The word “a” or “an” preceding an element does not exclude the presence of a plurality of such elements.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

1. A wireless communication system for an aircraft comprising: a router, an antenna, a control unit, and an antenna steering unit; wherein:
the router is connected to the antenna;
the router is configured to transmit and receive wireless data communication to and from a stationary communication server outside the aircraft through at least one ground base station via the antenna;
the antenna is a directional antenna;
the control unit is configured to determine an attitude change of the aircraft by determining a change in at least one of a roll angle, a pitch angle, and a yaw angle of the aircraft;
the antenna steering unit is connected to the control unit; and
the antenna steering unit is configured to steer an antenna beam of the directional antenna based on the attitude change of the aircraft.

2. The wireless communication system according to claim 1, wherein the antenna steering unit steers the antenna beam of the directional antenna to compensate for the attitude change.

3. The wireless communication system according to claim 1, wherein the antenna steering unit steers the antenna beam of the directional antenna to maintain a direction towards a predetermined sector of a ground surface below the aircraft by compensating for the attitude change.

4. The wireless communication system according to claim 1, wherein:
the directional antenna is a phased array antenna; and
the antenna steering unit is configured to electronically steer the antenna beam.

5. The wireless communication system according to claim 1, wherein:
the antenna steering unit comprises a mechanical steering element; and
the antenna steering unit is configured to mechanically steer the antenna beam.

6. The wireless communication system according to claim 1, wherein:
the control unit is configured to determine at least one of a pitch angle and a roll angle of the aircraft; and
the antenna steering unit is configured to steer the antenna beam to deviate it from a nominal bore-sight direction by a deviation angle based on the at least one of the pitch angle and the roll angle.

7. The wireless communication system according to claim 1, wherein:
the control unit is configured to determine a change in yaw angle of the aircraft; and
the antenna steering unit is configured to steer the antenna beam to deviate it from a nominal bore-sight direction by a deviation angle based on the change in a yaw angle of the aircraft.

8. The wireless communication system according to claim 1, wherein:
the router is connected to a plurality of directional antennas defining at least two groups of directional antennas;
each group comprises at least one directional antenna;
each group is configured to radiate and receive radio waves towards and from a selected sector of a ground surface below the aircraft; and
the selected sector is at least mostly non-overlapping.

9. The wireless communication system according to claim ##8, wherein the antenna steering unit is configured to steer one or more of antenna beams of each group based on the attitude change of the aircraft to compensate for the attitude change.

10. The wireless communication system to claim ##8, wherein the antenna steering unit is configured to steer one or more of antenna beams of each group when the aircraft makes a change in attitude to maintain a direction towards the selected sector of a ground surface below the aircraft by compensating for the attitude change.

11. The wireless communication system according to claim 8, wherein:
the control unit is configured to evaluate a data link quality between each group and the at least one ground base station in the selected sector; and
the antenna steering unit is configured to steer one or more of antenna beams to radiate and receive radio waves towards and from a new sector of the ground surface below the aircraft when the data link quality is below a predefined quality threshold value.

12. The wireless communication system according to claim 11, wherein the new sector is in a direction in front of the aircraft along a planned traveling route.

13. The wireless communication system according to claim 11, wherein the antenna steering unit is configured to select the new sector by steering one or more of antenna beams along a search pattern until the data link quality is above a predefined establishment threshold value.

14. The wireless communication system according to claim 11, wherein the antenna steering unit is configured to steer one or more of antenna beams such that a direction of the one or more of antenna beams is maintained towards the selected sector while steering the one or more of antenna beams to radiate and receive radio waves towards and from the new sector.

15. The wireless communication system according to claim 1, further comprising at least one of a gyroscope and an accelerometer to determine the attitude change.

16. A method for wireless data communication between a wireless communication system in an aircraft and a stationary communication server outside the aircraft, comprising the steps of:
(1) providing a router within the aircraft, wherein the router is connected to a directional antenna and configured to transmit and receive wireless data communication to and from the stationary communication server outside the aircraft through at least one ground base station via the directional antenna;
(2) determining an attitude change of the aircraft by determining a change in at least one of a roll angle, a pitch angle, and a yaw angle of the aircraft; and
(3) steering an antenna beam of the directional antenna based on the attitude change of the aircraft.

17. The method according to claim 16, wherein step (3) further comprises maintaining a direction towards a predetermined sector of a ground surface below the aircraft by compensating for the attitude change.

18. The method according to claim 16, further comprising the steps of:
evaluating a data link quality between each group of at least two groups of directional antennas and the at least one ground base station in a selected sector of a ground surface below the aircraft; and
steering the antenna beam such that at least one antenna in at least one of the evaluated group radiates and receives radio waves towards and from a new sector of the ground surface when the data link quality is below a predefined quality threshold value;
wherein:
the router is connected to a plurality of directional antennas defining the two groups of directional antennas;
each of the two groups of directional antennas comprises at least one directional antenna;
each of the two groups of directional antennas is configured to radiate and receive radio waves towards and from the selected sector; and
the selected sector is at least mostly non-overlapping.
